(19) United States
(12) Patent Application Publication
(10) Pub. No.: US 2001/0036259 A1
(43) Pub. Date: Nov. 1, 2001

(54) Process for supporting the establishment of communications connections

(76) Inventor: Sascha Larger, Stuttgart (DE)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/836,335

(22) Filed: Apr. 18, 2001

(30) Foreign Application Priority Data
Apr. 28, 2000 (DE) 100 20 911.4

(51) Int. Cl. H04M 3/42

(52) U.S. Cl. 379/211.02

(57) ABSTRACT

The invention relates to a process for supporting the establishment of communications connections between a calling subscriber (B) and a called subscriber (A) via a communications network (TELENET) and to a service unit for the execution of the process. A set of call numbers from the call number area of the communications network (TELENET) is assigned to a service unit (NESERV) of the communications network (TELENET). The service unit (NESERV) manages the set of call numbers which it has been assigned in that, at the request of service users (A), it assigns call numbers (RN) from the set of call numbers to service users (A) as temporary call numbers. For such time as a call number from the set of call numbers is assigned to a service user (A) as temporary call number, the service unit (NESERV) initiates a call forwarding within the communications network (TELENET) by which calls directed to this temporary call number of the service user (A) are forwarded to a terminal (TE1 to TE3) of this service user (A).

The invention relates to a process for supporting the establishment of communications connections between a calling subscriber and a called subscriber via a communications network and to a service unit for supporting the establishment of communications connections between a calling subscriber and a called subscriber via a communications network.

An important task in the operation of communications networks is that of number management. This is to be understood as management of the assignment of subscriber lines to telephone numbers in the routing tables of the communications network's switching centers, i.e. management of the addressing of subscriber terminals within the communications network.

The article “System 12, Operation and Maintenance” by E. Bertoli et al., published in “Elektrisches Nachrichtenwesen”, Vol. 56, No. 2/3, 1981, p. 184 to 198 describes an implementation of number management for a part of a telephone network.

The assignment of call numbers to the subscriber lines of one or more switching centers is controlled by a central operation and maintenance control center. This assignment is changed by blocking and releasing subscriber lines and changing the routing tables of the switching centers. A change of this kind is executed by the inputting of an appropriate change request by the operating personnel of the operation and maintenance control center.

The execution of such changes constitutes a management function of the network operator subject to strict security requirements. Therefore such a change request can be input only from specified operating terminals of the operation and maintenance control center and the operating personnel must be authorised by passwords.

It is also known to offer IN services (IN=Intelligent Network) by means of service units within communications networks. These services use only the communications infrastructure of the communications network and cannot influence the association between subscriber line and call number specified in the communications network. These services are activated for example by the dialling of a specific service call number. The dialling of the service call number initiates the execution of the IN service, is assigned to this service call number, by the service unit.

The object of the invention is to achieve a more customer-friendly connection establishment via a communications network.

This object is achieved by a process for supporting the establishment of communications connections according to the theory of claim 1 and by a service unit for supporting the establishment of communications connections according to the theory of claim 10.

The invention is based on the principle of facilitating the assignment of temporary call numbers to subscribers by means of a service. For this purpose a set of call numbers is assigned to the service. The service manages these call numbers and at the request of service users assigns call numbers from this set of call numbers to service users as temporary call numbers.

The advantage of the invention consists in that in this way temporary call numbers can be offered very rapidly to subscribers of the communications network. Furthermore no intermediary in the form of the operating personnel of the network operator is required for this purpose. Rather, temporary call numbers can be offered as a special service by independent service operators. As no intervention in the routing tables of the communications network is required, advantages are also achieved from the standpoint of operating security.

Further advantages of the invention consist in that the permanent personal call number of a service user is hidden. Thus for example, the service user can use the temporary call number to advertise a car or property in the newspaper. At the end of the assignment of the temporary call number, the service user is protected from further calls relating to this advertisement. It is also possible for dealers, travel bureaus and so on to use the service to assign temporary call numbers to special objects or offers.

Further advantageous developments of the invention are described in the Sub-Claims.

In the following the invention will be explained by way of example in the form of several exemplary embodiments making reference to the attached drawings in which:

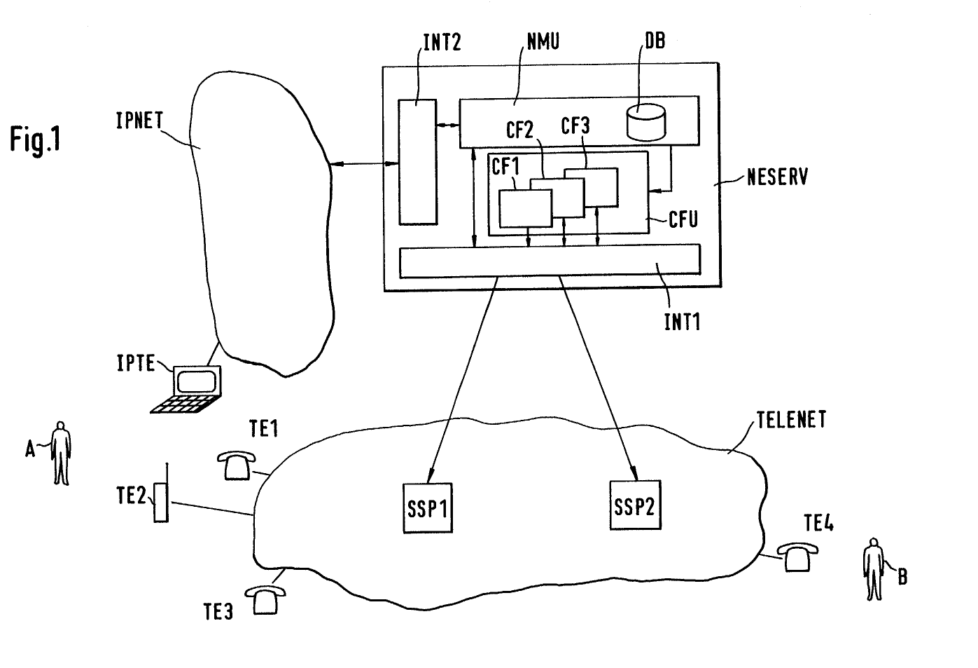

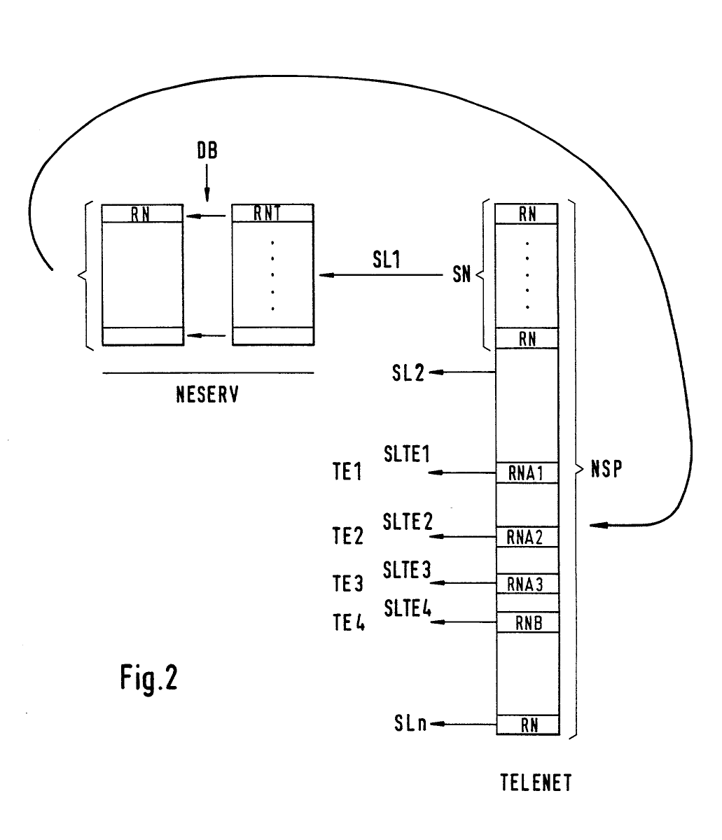

FIG. 1 is a block circuit diagram of a communications system with a service unit according to the invention and FIG. 2 is a diagram illustrating the assignment of call numbers as temporary call numbers.

FIG. 1 illustrates two communications networks TELENET and IPNET, a service unit NESERV, five terminals TE1, TE2, TE3, TE4, IPTE and two subscribers A and B of the communications network TELENET. The terminals TE1, TE2 and IPTE are assigned to the subscriber A and the terminal TE4 is assigned to the subscriber B. The number of terminals and subscribers and the assignment thereof has been selected by way of an example.

The communications network TELENET is a telephone network.

It facilitates the communication between the terminals TE1 to TE4. The communications network TELENET here is formed by a mobile telephone network, for example a cellular mobile telephone network conforming to the GSM standard (GSM=Global System Mobile Communication) and a fixed network, for example an ISDN telephone network (ISDN=Integrated Services Digital Network). It is of course also possible for the communications network TELENET to be formed only by a fixed network or by a mobile telephone network. It is also possible for the communications network TELENET to additionally comprise one or more further telephone networks (mobile telephone networks or fixed networks) or a data network (e.g. for voice-over IP) which can also be associated with different network operators.

The communications network TELENET comprises a plurality of specially designed switching centers which perform a service switching function according to an IN architecture (IN=Intelligent Network). Of these switching centers, two service switching points SSP1 and SSP2 have been illustrated by way of example in FIG. 1.

The communications network IPNET is an IP network, i.e. a data network using the IP protocol (IP=Internet Protocol) as layer 3 communications protocol. The terminal IPTE is a terminal which is equipped with the communications components required for the communication via the communications network IPNET. The terminal IPTE consists for example of a computer with a WEB browser equipped with a modem or network card.

The service unit NESERV is a network server which makes available network services within the communications network TELENET, for example a network server which influences the connection control of the communications network TELENET via IN- or WAP mechanisms (IN=Intelligent Network, WAP=Wireless Application Protocol). The service unit NESERV can also form part of the control unit of a switching center of the communications network TELENET and make available an ISDN-based service within the communications network TELENET. In the following it will be assumed that the service unit NESERV influences the connection control of the communications network TELENET via IN-mechanisms.

A set of call numbers from the call number area of the communications network TELENET is assigned to the service unit NESERV of the communications network TELENET. The service unit NESERV manages the set of call numbers which it has been assigned and at the request of server users, for example at the request of the subscriber A, assigns call numbers from the set of call numbers to service users as temporary call numbers. For such time as a call number from the set of call numbers is assigned to a service user as temporary call number, the service unit NESERV initiates a call forwarding within the communications network TELENET by which calls directed to this temporary call number of the service user are forwarded to a terminal of this service user, for example to the terminal TE1 or TE2. If, for example, by dialling the temporary call number of the subscriber A, the subscriber B initiates the establishment of a communications connection via the communications network TELENET, a call with the subscriber's temporary call number, managed by the service unit NESERV, is routed through the communications network TELENET. In this call, the service unit NESERV then converts the called temporary call number of the subscriber A into a call number assigned to a terminal of the subscriber A within the communications network TELENET, for example into the call number of the terminal TE1 or TE2. The service unit NESERV thus provides the subscriber A with a temporary call number within the numbering area of the communications network TELENET.

The detailed construction of the service unit NESERV will now be described in the following.

The service unit NESERV serves to support the establishment of communications connections between calling subscribers and called subscribers via the communications network TELENET. The service unit NESERV is formed by one or more computer(s) connected via a communications medium, forming the basis of a SW system platform consisting for example of an operating system and a database system, and applications programs. When run on the system platform of the service unit NESERV, these applications programs control the functions of the service unit NESERV and thus control the provision of the functions of the service unit NESERV to be described in the following.

From a functional standpoint the service unit NESERV comprises two communications units INT1 and INT2, a number management unit NMU and a call forwarding unit CFU.

The communications unit INT1 serves to communicate with elements of the communications network TELENET, for example with service switching points of the communications network TELENET.

The communications unit INT1 makes available the communications mechanisms necessary for the provision of a service within the communications network TELENET. The protocol stack processed for this purpose, for example for an IN connection from the communications unit INT1, consists of No. 7 protocols used as transport protocols and an INAP protocol stacked thereon (INAP=Intelligent Network Application Protocol). It is also possible to user other transport protocols, for example an ETHERNET protocol or another LAN protocol (LAN=Local Area Network) on which an IP protocol is stacked. INAP protocols specially adapted to mobile telephone networks can also be used.

Within the IN architecture, the service unit NESERV performs a service control function and thus constitutes a service control point conforming to IN architecture which communicates with one or more service switching points of the communications network TELENET. The functions required for the communication between service control function and service switching function are likewise performed by the communications unit INT1.

The communications unit INT2 makes available the communications mechanisms required for the communication via the communications network IPNET. The protocol stack for this communication consists for example of a LAN protocol (LAN=Local Area Network) or ATM protocol (ATM=Asynchronous Transfer Mode) on which a TCP/IP protocol stack is placed (TCP=Transport Capability Protocol). The communications unit INT2 could also be omitted.

The number management unit NMU manages the set of call numbers from the call number area of the communications network which is assigned to the service unit NESERV within the communications network TELENET. It specifies the assignment of the call numbers from the set of call numbers to subscribers of the communications network TELENET, stores this assignment and controls the changes to this assignment. In so doing it assigns call numbers from the set of call numbers to service users as temporary call numbers. It implements this assignment of temporary call numbers to subscribers using a database DB in which these assignments are stored.

The assignment of call numbers within the communications network TELENET effected by the number management unit NMU will be explained in the form of an example making reference to FIG. 2.

FIG. 2 illustrates a numbering area NSP containing a plurality of call numbers RN, RNA1, RNA2, RNB which are assigned to subscriber lines SL1, SL2, SLTE1 to SLTE4 and SLn by the routing tables of the switching nodes of the communications network TELENET. These subscriber lines are in turn assigned to terminals of the telecommunications network TELENET. Thus the terminals TE1, TE2, TE3 and TE4 are in each case assigned to the subscriber lines SLTE1 to SLTE4 respectively.

A set SN of call numbers RN of the numbering area NSP is assigned to the subscriber line SL1 which is allocated to the service unit NESERV. This set RN of call numbers need not necessarily relate to a continuous call number area. The call numbers RN of this set SN of call numbers are managed by the service unit NESERV and form potential temporary call numbers RNT. If a call number from the set SN of call numbers is assigned as temporary call number RNT to a subscriber of the communications network TELENET by the service unit NESERV, this call number is assigned by the database DB to this subscriber and thus to at least one call number RN from the numbering area NSP.

The number management unit NMU shown in FIG. 1 manages the call numbers from the set of call numbers and at the request of service users assigns call numbers from the set of call numbers to service users as temporary call numbers.

Here service users are subscribers of the communications network TELENET who use the service made available by means of the service unit NESERV.

Service users preferably access the number management unit NMU via the communications network IPNET and the communications unit INT2, for example by means of the terminal IPTE. The number management unit now provides service users with a WEB interface by means of which the service users can request the assignment of a temporary call number to this service user or to another service user by means of an IP terminal with a WEB browser.

However, the number management unit NMU can also be accessed by means of a terminal which supports the WAP protocol (WAP=Wireless Application Protocol). It is also possible for the call management unit NMU to provide, instead of or in addition to a WEB and/or WAP interface, an IN service enabling temporary call numbers to be requested by subscribers of the communications network TELENET via a normal terminal, preferably a mobile telephone terminal. In this case the number management unit NMU would be accessed via the communications unit INT1.

To request a temporary call number, a service user, for example the subscriber A, accesses the number management unit NMU via an IP terminal, for example the IP terminal IPTE. The number management unit NMU then determines the identity of the service user and preferably performs an authentication procedure to ensure the identity of the service user. Then the number management unit NMU asks the service user to request a temporary call number. If the requested temporary call number has not yet been issued to another service user, in the database DB the number management unit NMU assigns this temporary call number to the requesting service user or to another service user indicated in the request by the service user. The number management unit NMU also assigns one or more call number(s) of the communications network TELENET to the service user in the database DB. This assignment can take place automatically. For example the service user can be identified by his call number so that only an assignment of temporary call numbers to subscriber numbers is stored in the database DB. The call numbers can also be taken from a subscriber-specific user profile, or a reference to such a user profile can be contained in the database DB. A service user can set up a user profile of this kind by accessing the number management unit NMU. However, a user profile set up for another service can also be accessed. It is of course also possible for this/these call number(s) to be indicated in the request by the service user.

It is advantageous that upon requesting a temporary call number, the number management unit NMU sends the service user information about those numbers from the set of call numbers which are not yet assigned to a service user as temporary call numbers. The service user can for example be sent a list of as yet unissued call numbers and from this list can then select the call number which he likes best as his temporary call number.

It is also advantageous that, upon requesting a temporary call number, the service user (A) selects a time period during which the temporary call number is made available to him by the service unit NESERV. This time period is sent by the service user to the number management unit NMU or is selected by the service user from a (free) time period sent to him by the number management unit NMU. The selected time period is stored in the database DB with the assignment. The selected time period can also be in the future. Prior to entry, the number management unit NMU checks whether the desired call number is still free during the desired time period. The number management unit NMU can also provide a specified minimum time period between the use of a temporary call number by two different service users, in which time period the call number is not assigned to any service user as temporary call number.

It is also advantageous that, upon requesting a temporary call number, the service user specifies the type of charging for calls directed to the temporary call number, for example whether the call number is to be a call number which is charge-free, or incurs a reduced charge, for the caller. This information is then stored in the database DB by the number management unit NMU with the corresponding assignment.

It is also advantageous for the number management unit NMU to determine a personal user profile of the service user and for this user profile, or a reference thereto, to be stored in the database DB with the corresponding assignment. In the personal user profile of the service user, two or more terminals are assigned to the service user. These terminals are allocated further parameters defining criteria for the selection of one of these terminals.

It is also advantageous for a service user to be automatically charged by the service unit NESERV for the provision of a temporary call number. For this purpose, for example, the service unit sends a charging message to the charging control center of the operator of the communications network TELENET. The level of charging can depend for example upon the time period for which the temporary call number is assigned to the service user. It is also possible for a charge to be incurred upon each use of the temporary call number by a calling subscriber and for a corresponding charging message to be generated and transmitted.

The call forwarding unit CFU comprises several call forwarding logic functions CF1 to CF3.

For such time as a call number from the set of call numbers is assigned to a service user as temporary call number, the call forwarding unit CFU initiates a call forwarding within the communications network TELENET by which calls directed to this temporary call number of the service user are forwarded to a terminal of this service user.

For this purpose the call forwarding unit CFU accesses the database DB of the number management unit NMU. From the database DB the call forwarding unit CFU then extracts the information about the temporary call numbers to which subscribers are assigned, the subscribers to which these call numbers are assigned, and the time period in which said call numbers are assigned to said subscribers. In accordance with this information, the call forwarding unit CFU then generates and terminates call forwarding logic functions, for example the call forwarding logic functions CF1 to CF3.

The call forwarding logic functions CF1 to CF3 each control a call forwarding from a temporary call number to one or more call numbers assigned to this temporary call number in accordance with the database DB. For this purpose, via the communications unit INT1 they send control commands to the service switching points SSP1 and SSP2 instructing these, in the case of calls directed to the relevant temporary call number, to convert the called call number into a call number assigned to a terminal of the assigned service user within the communications network TELENET.

If for example the terminal TE4 sends the communications network TELENET a connection request which is directed to a temporary call number assigned to the subscriber A, a service switching point of the communications network TELENET, for example the service switching point SSP1, is triggered for this call. The service switching point SSP1 sends a corresponding service request message to the service unit NESERV, whereby the call forwarding logic function assigned to the temporary call number, for example the call forwarding logic function CF1, is triggered for this call. If several call numbers of the subscriber A are assigned to the temporary call number in the database DB, the call forwarding logic function selects one of these call numbers by means of the assigned parameter data.

The call forwarding logic function CF1 then forwards the call by sending the service switching point SSP1 a corresponding INAP command indicating the determined call number and thereby instructing the service switching point SSP1 to forward the “waiting” call with this determined call number as call number of the called subscriber and thus to initiate a call forwarding to this determined call number.

1. A process for supporting the establishment of communications connections between a calling subscriber (B) and a called subscriber (A) via a communications network (TELENET), characterised in that a set (SN) of call numbers (RN) from the call number area (NSP) of the communications network (TELENET) is assigned to a service unit (NESERV) of the communications network (TELENET), that the service unit (NESERV) manages the set (SN) of call numbers which it has been assigned, and at the request of service users (A) assigns call numbers (RN) from the set (SN) of call numbers to service users (A) as temporary call numbers (RNT), that for such time as a call number (RN) from the set (SN) of call numbers is assigned to a service user (A) as temporary call number (RNT), the service unit (NESERV) initiates a call forwarding within the communications network (TELENET), by which calls directed to this temporary call number (RNT) of the service user (A) are forwarded to a terminal (TE1 to TE3) of this service user (A), in that in the case of such calls the service unit (NESERV) converts the called temporary call number (RNT) into a call number (RN) assigned to a terminal (TE1 to TE3) of the service user (A) within the communications network (TELENET).

2. A process according to claim 1, characterised in that upon requesting a temporary call number (RNT), the service user (A) is sent information by the service unit (NESERV) about those call numbers from the set of call numbers which are not yet assigned to a service user (A) as temporary call number (RNT).

3. A process according to claim 1, characterised in that upon requesting a temporary call number (RNT), the service user (A) selects a time period during which it is assigned the temporary call number (RNT) by the service unit (NESERV).

4. A process according to claim 1, characterised in that upon requesting a temporary call number (RNT), the service user (A) specifies the type of charging for calls directed to the temporary call number (RNT).

5. A process according to claim 1, characterised in that upon the initiation of a call forwarding, the service unit (NESERV) assigns a temporary call number (RN) two or more terminals of a service user in accordance with a personal user profile of the service user (A).

6. A process according to claim 1, characterised in that a service user (A) is charged by the service unit (NSERV) for the provision of a temporary call number (RNT).

7. A process according to claim 1, characterised in that a service user (A) requests the assignment of a temporary call number (RNT) by the service unit (NESERV) via a WEB interface (INT1).

8. A process according to claim 1, characterised in that a service user requests the assignment of a temporary call number (RNT) by the service unit (NESERV) via an IN service.

9. A process according to claim 1, characterised in that a service user requests the assignment of a temporary call number by the service unit via a WAP interface.

10. A service unit (NESERV) for supporting the establishment of communications connections between a calling subscriber (B) and a called subscriber (A) via a communications network (TELENET), characterised in that the service unit (NESERV) is provided with a number management unit (NMU) which is designed such that it manages a set (SN) of call numbers (RN) from the call number area (NSP) of the communications network (TELENET) which is assigned to the service unit (NESERV) within the communications network (TELENET), and at the request of service users (A) assigns call numbers (RN) from the set (SN) of call numbers to service users (A) as temporary call numbers (RNT), that the service unit (NESERV) is provided with a call forwarding unit (CFU) which is designed such that for such time as a call number (RN) from the set (SN) of call numbers is assigned to a service user (A) as temporary call number (RNT), the service unit (NESERV) initiates a call forwarding within the communications network (TELENET) by which calls directed to this temporary call number (RNT) of the service user (A) are forwarded to a terminal (TE1 to TE3) of this service user (A) in that in the case of such calls the service unit (NESERV) converts the called temporary number (RNT) into a call number (RN) assigned to a terminal (TE1 to TE3) of the service user within the communications network (TELENET).

11. A service unit (NESERV) according to claim 10, characterised in that the service unit is provided with an interface unit (INT2) which is designed such that it allows service users (A) to access the number management unit (NMU) via an IP network (IPNET).

12. A service unit (NESERV) according to claim 10, characterised in that the service unit (NESERV) is a service control point conforming to IN architecture which communicates with one or more service switching points (SSP1 to SSP2) of the communications network (TELENET).
